(19) United States
(12) Patent Application Publication
(10) Pub. No.: US 2008/0227057 A1
(43) Pub. Date: Sep. 18, 2008

(54) Narrow Dental Implant and Associated Parts

(75) Inventor: Eduardo Anitua Aldecoa, Vitoria (ES)

Correspondence Address: BROWDY AND NEIMARK, P.L.L.C.;624 NINTH STREET, NW, SUITE 300, WASHINGTON, DC, 20001-5303, US

(73) Assignee: Biotechnology Institute.I Mas D. S.L., Vitoria (ES)

(21) Appl. No.: 11/815,849

(22) PCT Filed: Feb. 8, 2005
(86) PCT No.: PCT/ES2005/000057

§ 371 Date: May 7, 2008

(51) Int. Cl. A61C 8/00

(52) U.S. Cl. 433/174

(57) ABSTRACT

New platform comprising a dental implant (1) and associated parts characterised in that both the implant (1) and the associated parts have a reduced diameter that makes them suitable for certain applications, particularly for treating narrow areas of a bone crest. In order to be able to achieve a dental implant (1) and associated parts that are narrow but still robust and reliable. certain characteristics and geometrical forms of the dental implant (1) and the associated parts have been readjusted or optimized.

### TECHNICAL FIELD

The invention relates to a dental implant and other parts associated to it that enable the fitting or installing of one or more dental prosthesis or artificial teeth in the maxillary bone of a patient.

### PRIOR ART

As is well known in the prior art, dental implants are generally threaded parts that are inserted into the maxillary bone of a patient and to which, following a process of osseointegration or bone integration of the implant in said maxillary bone (or even before osseointegration takes place), a dental prosthesis with one or more artificial teeth is affixed. To achieve this, a series of associated parts are needed. These associated parts enable the insertion of the implant into the maxillary bone, the fixing of the dental prosthesis, and other actions.

Dental implants and associated parts in current use, including the dental implants in document WO-0224102-A1, filed by the applicant, have certain characteristics that prevent them from being used satisfactorily in certain treatment and rehabilitation applications and strategies. Specifically, in certain applications, some examples of which will be given below, implants have been shown to be essentially too thick. In other words, their external diameters are too large for the requirements of the application.

A first application or rehabilitation strategy in which the performance of implants with conventional diameters can be improved is that in which one or more implants are to be installed in the wide area of a hybrid maxillary bone crest (maxillary bone that has wider and narrower areas of bone crest). This is for example the case of a patient with partial or complete edentulism (lack of teeth). In this rehabilitation strategy, it is common for the patient to continue using their dentures while the implants installed in the wide areas of the maxillary bone osseointegrate. This is extremely uncomfortable and unpleasant as the dentures are disposed in such a way that they press on the implants (if the implants are visible) or on the gums covering the implants (if the implants are hidden).

A second application in which the use of implants with conventional diameters is not entirely satisfactory is that in which an implant is installed in a narrow area of a maxillary bone crest. In order to install conventional implants in the narrow areas of a maxillary bone crest it is currently common practice to carry out a process of widening said narrow crest beforehand, or even a process of implanting hip and calvarian bone grafts, etc. These processes involve complex surgery, besides having to wait an additional time for the widened crest bone to regenerate or for the graft to settle. For all patients, in particular certain types such as elderly patients or patients at risk (smokers, etc.), the widening of the crest or the use of grafts are in fact to be avoided.

A third application in which the use of implants of conventional diameters is not entirely satisfactory is that in which various implants are to be installed in adjacent narrow and wide areas of a hybrid maxillary bone. One current common practice involves the fitting of one or two conventional dental implants in the wide area; then, a projection or bridge piece are connected to the dental implants; finally, various prosthetic elements are connected to the projection or bridge piece. In other words, the application allows a single dental implant or two interconnected dental implants to support several artificial dental parts. The drawback with this system is that only one or two dental implants must endure the local mechanical forces of all the prosthetic elements that they carry, these mechanical forces being of all types and directions. As a consequence, the implants can easily fail, leading to the appearance of a certain mobility in the implants or in the prosthodontic components connected to the implants.

A fourth application in which the use of implants of conventional diameters is not entirely satisfactory is that in which a dental implant and a dental prosthesis are to be installed in a maxillary area, be it wide or narrow, with the requirement that the dental prosthesis be positioned at the same time as the implant is fitted, in other words, without waiting weeks or months for the osseointegration of the implant in the maxillary bone to occur. This practice, known as ‘immediate loading’, is becoming increasingly common due to the increasingly frequent need to find rapid and effective surgical-prosthodontic solutions. It represents a challenge in oral surgery due to its difficulty, mainly in terms of preventing faults such as the anchoring or installation of the implant working loose. Using conventional implants, the number of patients upon which immediate loading can be practised is in fact greatly reduced, mainly because the patient's maxillary bone must be very high quality so that there are enough chances that the implant anchors properly.

With regard to the associated prosthodontic parts and surgical parts that accompany the dental implants, it has been observed during their use that some of these parts can also be improved. This is the case, for example, with the transephitelial abutment, which is the part that is connected to the dental implant during the creation of an impression or mould of the patient's mouth, and also during the subsequent permanent connection of the dental prosthesis (artificial tooth).

The process of creating an impression is essentially as follows. First, a series of dental implants, their corresponding transephitelial abutments, screws for fastening the transephitelial abutments to the implants, impression copings and impression screws are installed in the patient's maxillary bone. Then, an impression material is inserted into the patient's mouth. The impression material is a soft mass that eventually takes the form of the inside of the patient's mouth, creating a ‘negative’ of the maxillary bone and the implants that may subsequently be ‘formed into a positive’ in the laboratory. When the impression material has set, the impression screws are loosened and removed. Then, the impression, in which the impression copings are embedded, is removed. The impression copings are separated from the transephitelial abutments during the extraction of the impression.

Due to the irregular alveolar process (the irregular shape of the maxillary bone) of each patient, the implants fitted in each maxillary bone have different inclinations or angulations. Therefore, so do the parts connected to the implants. As a result, separating the impression copings from the transpehitelial abutments, and therefore extracting the impression, may be difficult or impossible if the implants are disposed at very different angulations. If so, the person performing the surgery must wobble the impression back and forth in order to disengage the impression copings and remove the impression from the patient's mouth. This inappropriate and rough handling of the impression undermines the initial stability of the recently fitted implants, thus jeopardising the end result of the surgery.

Having the implants disposed at very different angulations can also be an obstacle in other steps and procedures of the treatment, e.g. when trying to connect the dental prostheses to the implants.

It is an objective of the invention to design a dental implant that provides increased patient comfort during certain treatment strategies, by providing solutions and alternatives that are more comfortable than those offered by conventional techniques. it is another objective of the invention to design a dental implant that, in certain treatment strategies, does not require performing traumatic processes such as the widening of narrow crests or the use of hip and calvarian bone grafts.

It is another objective of the invention to design a dental implant by virtue of which in those treatment strategies where there is not enough space in the maxillary bone for a conventional dental implant and where prior art requires the use of projections, the use of projections can in fact be avoided.

It is another objective of the invention to design a dental implant and associated transehitelial abutment that enable a better anchoring of the implant to the maxillary bone in immediate loading strategies, thereby improving the implementation of said strategies.

It is another objective of the invention to design a dental implant that is suitable for the aforementioned treatment strategies and which also offers a robustness or lack of breakage points comparable to that of the narrowest conventional implants among known conventional implants (i.e., implants with a diameter of 3.3 mm). In this way, these dental implants, which in principle could be considered as transitional (not permanent), may also be used as permanent implants, i.e. as implants that are designed to be inserted permanently in the maxillary bone of the patient.

It is another objective of the invention to design transephitelial abutments and associated parts that allow extracting an impression from the patient's mouth more easily and efficiently. Also, the transephitelial abutments and associated parts must allow connecting the transitional prostheses on said transephitelial abutments more easily and efficiently in the event that the patient has various implants at very different angulations, a very common situation when immediate loading is performed.

It is another objective of the invention to achieve a design that acts as an anchor for orthodontic treatments such as the straightening of a flattened second molar.

### DETAILED DESCRIPTION OF THE INVENTION

In order to achieve the aforementioned objectives, the invention defines a narrow dental implant and a series of associated components or parts related to said implant.

Similarly to conventional implants, the dental implant according to the invention comprises a head, a threaded body and an apical end or apex. The implant is solid and comprises a blind threaded hole for the connection of a screw. The dental implant according to the invention is categorised as ‘narrow’ because one of its essential innovative characteristics is that it presents a reduced thickness or diameter in comparison with prior art implants. This innovative characteristic is accompanied by other additional changes in the design of the implant, so that the reduction of the thickness of the implant does not reduce the implant's robustness, preloading capability, ability to prevent the appearance of breakage points, and other necessary qualities.

The narrow dental implant according to the invention has the following characteristics:

The threaded body of the implant comprises a cylindrical threaded area and a lower conical threaded area, with the innovative characteristic that there is a second conical threaded area, or upper conical threaded area, between the head of the implant and the cylindrical threaded area. The cylindrical threaded area has an external diameter of between 2.5 and 3.25 mm and an internal diameter of between 1.9 and 2.7 mm. These diameters are smaller than the diameters of the prior art dental implants, giving the inventive dental implant its ‘narrow’ quality and making it suitable for certain applications, as will be explained at a later stage. The upper conical threaded area in turn has a length of 1.2 mm and has a thread that increases in depth as it approaches the cylindrical threaded area, said depth always being less than that of the threads of the cylindrical threaded area for the purpose of increasing the thickness of the wall of the implant in the area of the blind threaded hole and thereby providing the implant with greater solidity. Preferably, the upper conical threaded area comprises two complete turns of thread.

The head of the implant comprises a lower area, a cylindrical area and a hexagonal protuberance. The lower area has a conical shape for the purpose of providing greater primary stability to the implant, in comparison to an implant with identical characteristics but with a cylindrical lower area. This conical lower area of the head of the implant has a height of 1.8 mm and a maximum diameter of 3.5 mm. In addition, the hexagonal protuberance of the head of the implant presents innovative characteristics in the form of a diameter of its circumference ranging between 2.8 and 3.0 mm and a height of 1.1 mm. This height is greater than that of the hexagonal protuberances of conventional dental implants in order to provide greater leverage and in order to provide increased resistance to both mechanical torque forces during the insertion of the implant and lateral forces during mastication.

The blind threaded hole is shorter than the blind threaded holes in conventional dental implants, due to the fact that if the blind threaded hole formed in the narrow implant were as long as in conventional implants, the thickness of the narrow implant in the area of the blind threaded hole would be reduced to very fragile limits. The reduction in the length of the blind threaded has to be careful not to negatively affect the ‘preloading’ (force of the union between the implant and the prosthetic component by means of the screw). The optimal characteristics of the implant are achieved with a blind threaded hole of a length of between 2.5 and 3.0 mm and comprising a total of between 3 and 6 turns of thread. Additionally, the thread of the blind threaded hole has an internal diameter of between 1.3 and 1.7 mm and an external diameter of between 1.6 and 2.2 mm. Preferably, the section of the thread is not triangular: instead, its tip is rounded or bevelled. Also, the blind threaded hole may present a non-threaded first part to enable the screws to be inserted, the height of this first part preferably being 0.7 mm.

The combination of a shortened blind threaded hole, a conicity of the lower area of the head of the implant, and a reduction in the depth of the thread of the upper conical threaded area makes the implant according to the invention especially rigid and strong.

The invention contemplates the provision of narrow dental implants of different lengths, preferably with implant lengths of between 7.0 and 20.0 mm (where the length is calculated as the sum of the lengths of all its parts except the hexagonal protuberance). Of course, the invention does not discard using other lengths not comprised in this preferred range.

The parts associated to the implant are detailed below, along with their descriptions of their utility and innovative features.

The invention discloses a first unit of associated parts known as carrier unit, which comprises a bushing, an axis and a seal. Said carrier unit is used to carry and insert the dental implant into a bone cavity which has been previously drilled in the patient's maxillary bone by means of appropriate tools and procedures, not covered by this invention. The bushing of the carrier unit is connected directly to the head of the implant, and thus includes a hole in which the hexagonal protuberance of the implant's head is housed. Said hole has a height of 1.1 mm and a diameter of its circumference ranging between 2.8 and 3.0 mm. The axis of the carrier unit presents a threaded area with an external diameter of between 1.6 and 2.2 mm and an internal diameter of between 1.3 and 1.7 mm. The area of the axis that houses the seal has been widened in comparison with prior art carrier unit axes to an internal diameter of 1.7 to 1.9 mm, for the purpose of making the axis more rigid. In addition, the upper end of the axis is conical, so that the tightening achieved when the implant is screwed into the bone does not impact negatively on the axis. Additionally, the conical shape facilitates the removal of the key or tool that is connected to the axis by said upper conical area. Both these factors are desirable because the carrier unit performs a critical role; if an error is made during its use, the axis may break, giving rise to serious problems.

Another part associated to the dental implant is the healing abutment, which is a part that is screwed onto the implant to cover the implant during osseointegration and enable the gum to heal. The healing abutment is used when the implant is to remain visible (not embedded in the gum) during osseointegration. The healing abutment according to the invention is characterised in that it presents a threaded area provided with between 4 and 6 turns of thread, an external diameter of between 1.6 and 2.2 mm and an internal diameter of between 1.3 and 1.7 mm. The total height of the healing abutment is preferably 5.65, 6.65 and 8.65 mm.

Another part associated to the dental implant is the locking screw, which is a part that is threaded to the implant in order to cover the implant during osseointegration, in cases in which the implant is to be hidden from sight during said osseointegration. The locking screw according to the invention has a threaded area provided with between 3 and 6 turns of thread, an external diameter of between 1.6 and 2.2 mm and an internal diameter of between 1.3 and 1.7 mm. The threaded area finishes on a non-threaded end, which helps insert the locking screw in the blind threaded hole of the implant.

The invention also discloses a prosthesis retention screw and a final abutment, which are parts that are inserted permanently in the patient's mouth and which support a dental prosthesis. They are used when the implant is known as unitary, in other words, when an isolated dental prosthesis is installed. The prosthesis retention screw presents an external diameter of between 1.6 and 2.2 mm and an internal diameter of between 1.3 and 1.7 mm, and can be manufactured in titanium, gold, gold alloys, or other materials. The final abutment is connected directly to the head of the implant, and for this purpose comprises a hole in which the hexagonal protuberance of the implant's head is housed. The circumscribed circumference of said hole has a diameter that matches that of the hexagonal protuberance or male hex of the dental implant. In other words, the diameter is between 2.8 and 3.0 mm. The hole also has a height of 1.1 mm.

Other additional associated parts are the implant impression coping and the screw of the implant impression coping, which are connected to the implant before an impression is made in the mouth of the patient (the purpose of the impression being to prepare, in the laboratory, a duplicate of the position of the implant in the patient's mouth). The implant impression coping is connected directly to the head of the implant, and for this reason includes a hole in which the hexagonal protuberance of the implant's head is housed. The head comprises a cylindrical part and a hexagonal part, where the hexagonal part of the hole has a circumscribed circumference diameter that matches that of the hexagonal protuberance or male hex of the dental implant. In other words, the circumscribed circumference diameter is between 2.8 and 3.0 mm. Also, the hole presents a height of 1.1 mm. The cylindrical part ends in a rabbet. The screw of the implant impression coping comprises a threaded area with an external diameter of between 1.6 and 2.2 mm and an internal diameter of between 1.3 and 1.7 mm.

The invention also discloses a laboratory analog of the unitary implant, which is a part used to simulate the upper part of the dental implant during the laboratory process by which the positive shape of the patient's mouth is manufactured. While the body of the laboratory analog is provided with its own design characteristics for retaining the plaster, the head of the laboratory analog has the same characteristics as the head of the implant according to the invention. The head of the laboratory analog thus presents a cylindrical part with a diameter of 3.5 mm, followed by a hexagonal protuberance with a height of 1.1 mm and a circumscribed circumference diameter of between 2.8 and 3.0 mm. In addition, the laboratory analog is provided with a blind threaded hole with external and internal diameters of between 1.6 and 2.2 and between 1.3 and 1.7 mm respectively, this blind threaded hole preferably ending in a non-threaded area with a height of 0.7 mm for easing the insertion of screws.

The invention also discloses a transephitelial abutment, a first screw for fixing the transephitelial abutment to the implant, a gold cylinder and a second screw for fixing the gold cylinder to the first screw. These parts are permanently installed in the patient's mouth and are in charge of supporting a dental prosthesis composed of various dental parts, in those cases in which multiple implants are installed. In other words, they are used when the rehabilitation strategy involves installing several implants and one dental prosthesis with various dental parts, the dental prosthesis being connected simultaneously to more than one dental implant, overcoming angulation problems.

The transephitelial abutment according to the invention is connected directly to the head of the implant, and thus includes a central through hole with a cylindrical area in which the hexagonal protuberance of the implant's head is housed. Said area has dimensions that fit the hex of the implant precisely but which allow the rotation of the transephitelial abutment with respect to the implant, guaranteeing that the transephitelial abutment remains centred in relation to the implant at all times. Specifically, the cylindrical area has a diameter of 2.9 mm and a height of 1.1 mm. Additionally, in order to be able to more easily fit the transephitelial abutment onto the implant, said cylindrical area ends in a widened section in the form of a bevel or in the form of a rounded area. In the event that the widened section takes the form of a rounded area, said rounded area presents a radius of preferably 20 micron.

Additionally, the transephitelial abutment has a geometric design that allows connecting the prosthetic elements at different angles. Specifically, the transephitelial abutment presents an upper part that comprises a conical part, featured in that said upper part has a greatly reduced height to enable greater angulations and in that said upper part also comprises a cylindrical part for preventing the radial movement of the parts that are connected to the transephitelial abutment through said upper part. The height of the conical and cylindrical parts is 0.45 and 0.1 mm respectively, the diameter of the cylindrical part being between 3.3 and 3.5 mm. Transephitelial abutments of different sizes are contemplated, although preferred transephitelial abutments will have a total height of 1.5, 2.0. 3.0, 4.0, 5.0, 5.5 or 6.0 mm.

In addition to achieving greater angulations, that fact of having a transephitelial abutment with an upper part of a reduced height allows the physician to separate the gold cylinder or the provisional cylinder connected to the transephitelial abutment without having to apply tension forces.

For its part, the screw for fixing the transephitelial abutment to the implant is characterised in that it presents a threaded area provided with between 4 and 6 turns of thread, an external diameter of between 1.6 and 2.2 mm and an internal diameter of between 1.3 and 1.7 mm. Also, it presents various possible sizes or total heights that are adapted to the various sizes of the transephitelial abutments, these sizes preferably being between 4.7 and 7.2 mm. In addition, this screw is provided with a hexagonal protuberance whose height is less than that of the hexagonal protuberances of other known screws in the prior art with an identical function. Specifically, the height is between 0.9 and 1.1 mm, in order to achieve a dental unit of minimum height. Through this hexagonal protuberance, a blind threaded hole opens. The blind hole has a height of between 1.55 and 2.15 mm and a total of between 4 and 6 turns of thread. Also, the blind threaded hole presents an internal diameter of between 1.0 and 1.2 mm and an external diameter of between 1.9 and 2.1 mm.

The screw with which the gold cylinder is secured to the aforementioned first screw is adapted so that it can be connected to said first screw. It presents a threaded part provided with between 4 and 6 turns of thread, with an internal diameter of between 1.0 and 1.2 mm and an external diameter of between 1.9 and 2.1 mm.

The gold cylinder has a hole designed to house the upper part of the transephitelial abutment and the hexagonal protuberance of the first screw, said hole thus presenting a height of between 1.7 and 1.9 mm. Besides, the hole of the gold cylinder comprises a cylindrical part with a diameter of between 3.3 and 3.5 mm and a height of 0.4 mm. Said height is optimal for ensuring a correct connection/disconnection of the cylinder to/from the transephitelial abutment in the case of varied angulations. The height value is complemented by the fact that when the gold cylinder is connected to the transephitelial abutment, they come into contact with each other only in the cylindrical part of the hole of the gold cylinder, and not in the rest of said hole.

Additionally, the invention discloses an transephitelial impression coping and a screw of the transephitelial impression coping, which are connected to the implant and the transephitelial abutment before making an impression of the patient's mouth. The impression coping comprises a hole in which the conical and cylindrical parts of the upper part of the transephitelial abutment are housed. One of the fundamental characteristics of the impression coping is that its hollowed interior enables angulation problems to be solved. This hole has the same characteristics as those of the hole of the gold cylinder, with the same measurements and also comprising a cylindrical part that is the only part of the hole that comes into contact with the transephitelial abutment when the transephitelial abutment and the impression coping are connected together. In turn, the screw of the impression coping features a threaded area that comprises between 4 and 6 turns of thread and that has an internal diameter of between 1.0 and 1.2 mm and an external diameter of between 1.9 and 2.1 mm.

The invention also discloses a laboratory analog, which is a part used in the laboratory during the forming of the positive of the patient's mouth, for simulating the set of parts formed by the dental implant, the screw and the transephitelial abutment. Said laboratory analog features a head with the same characteristics as those of the upper part of the transephitelial abutment, but manufactured more simply and economically. For this reason, the head of the laboratory analog comprises a cylindrical part with a height of 0.1 mm and a diameter of between 3.3 and 3.5 mm.

All the threaded areas of the invention may be formed with a thread section that is either non-triangular or not provided with a pointed end, or either triangular or finished in a pointed end.

The invention also discloses a kit or set of parts that comprise one or more parts of the set of parts claimed by the invention. In other words, a kit comprising one or more narrow dental implants of the same or different sizes. and/or of one or more associated parts of the same or different sizes is also an object of the invention.

The narrow dental implants according to the invention provide many advantages. Firstly, even though the narrow implants have a very reduced diameter in comparison with the conventional implants, the design of the narrow implants allows said implants to offer greater resistance to flexion than the narrowest conventional implants (conventional implants of a diameter of 3.3 mm). Among many other applications, the narrow implant according to the invention can therefore be used as a definitive implant for replacing small-sized dental parts, such as central incisors, lower lateral incisors, or small upper lateral incisors.

Secondly, the invention also allows for the possibility of adopting different rehabilitation strategies in certain situations that are complex but nevertheless frequent, and that have been resolved up to now by other more limited strategies. Some examples of these situations have been mentioned in this document.

For example, one situation is that in which one or more conventional implants are to be installed in a narrow area of a hybrid maxillary bone crest. According to prior art, the patient was obliged to uncomfortably use their dentures while the conventional implants osseointegrated. Thanks to the invention, instead, narrow implants can be installed in the narrow areas of the maxillary bone while implants with conventional diameters osseointegrate in the wide areas. Then, while the conventional implants fitted in the wide area consolidate, the narrow implants may support transitional dental prostheses. This thus allows the patient to avoid having to use their uncomfortable dentures in the meantime that the conventional implants osseointegrate, which may last for at least several months.

Another situation is that in which an implant is to be installed in a narrow area of a maxillary bone crest. In this scenario, the narrow implant according to the invention may be installed as a permanent implant in the narrow area of the bone crest, without having to perform a widening of the crest beforehand or simply performing a minimal widening, with the narrow implant itself. In other words, the need for a crest-widening surgery is avoided.

Another situation is that in which several implants are to be installed in adjacent narrow and wide areas of a hybrid maxillary. Narrow dental implants allow performing improved treatments, in comparison with conventional treatments normally carried out using projections. For example, it is possible to install narrow implants in the narrow areas and thereby no longer need to connect projections to the conventional implants inserted in the wide areas. This thus improves the distribution of the mechanical forces in comparison with the conventional scenario, where mechanical forces were concentrated on one or two conventional implants, making them particularly vulnerable to lateral forces and torque.

Nevertheless, there may be cases in which the fitting of multiple prostheses on a series of conventional lateral implants is advisable, in which case the fitting of the prostheses may be strengthened with the insertion of one or more inventive narrow implants. In this way, the torque forces on the implants are reduced, thereby allowing them to support nothing more than compression forces.

Another situation is that in which a dental implant and a dental prosthesis are to be inserted into a maxillary area by means of an immediate loading process. The narrow implants according to the invention increase the anchoring of the prosthesis to the maxillary bone and improve the performance of immediate loading treatments. This is due to the fact that, for purely mechanical reasons, narrow implants achieve a better embedding in the jawbone than thicker conventional implants. Additionally, as the implant is narrow it can anchor itself both to the upper cortical and in the lower cortical areas of the maxillary bone. Anchoring the implant to both cortical areas would be very traumatic if the implant were conventional (thicker); thicker conventional implants are only anchored to the upper cortical area. For example, the implant may be positioned by the lingual or vestibular of the inferior alveolar nerve, thereby avoiding an anatomical structure that is difficult to avoid with a conventional implant.

An additional advantage offered by the narrow dental implant according to the invention is that the lower conical threaded area, being so narrow, enables the implant to present a greater penetration capability and even allows it to be fitted using only a single start drill. In addition, as the lower threaded area is both conical and narrow, the implant itself can perform the crest expansion, thereby reducing the number of procedures and the total operating time required in certain applications or scenarios.

### DESCRIPTION OF THE DRAWINGS

Details of the invention can be seen in the accompanying non-limiting drawings:

FIG. 1 shows an elevation and a cross-sectional elevation of a narrow dental implant according to the invention.

FIG. 2 shows an elevation of a carrier unit according to the invention.

FIG. 3 shows a cross-sectional elevation of the carrier unit of FIG. 2.

FIG. 4 shows an elevation and a cross-sectional elevation of the carrier unit of FIG. 2 assembled on the dental implant of FIG. 1.

FIG. 5 shows an elevation and a cross-sectional elevation of a healing abutment according to the invention.

FIG. 6 shows an elevation and a cross-sectional elevation of the healing abutment of FIG. 5 assembled on the dental implant of FIG. 1.

FIG. 7 shows an elevation and a cross-sectional elevation of a locking screw according to the invention.

FIG. 8 shows an elevation and a cross-sectional elevation of the locking screw of FIG. 7 assembled on the dental implant of FIG. 1.

FIG. 9 shows an elevation of a final abutment and a prosthesis retention screw according to the invention.

FIG. 10 shows a cross-sectional elevation of the final abutment and of the prosthesis retention screw of FIG. 9.

FIG. 11 shows an elevation and a cross-sectional elevation of the final abutment and of the prosthesis retention screw of FIG. 9 assembled on the dental implant of FIG. 1.

FIG. 12 shows an elevation of an implant impression coping and of a screw of the implant impression coping according to the invention.

FIG. 13 shows a cross-sectional elevation of the implant impression coping and of the screw of FIG. 12.

FIG. 14 shows an elevation and a cross-sectional elevation of the implant impression coping and of the screw of FIG. 12 assembled on the dental implant of FIG. 1.

FIG. 15 shows a partial a cross-sectional elevation of a laboratory analog of the unitary implant according to the invention.

FIG. 16 shows an elevation of a transephitelial abutment, a first screw for fixing the transephitelial abutment to the implant, a gold cylinder and a second screw for fixing the gold cylinder to the first screw, according to the invention.

FIG. 17 shows a cross-sectional elevation of the parts of FIG. 16.

FIG. 18 shows an elevation and a cross-sectional elevation of the transephitelial abutment, the first screw, the gold cylinder, the provisional cylinder and the second screw of FIG. 16 assembled on the dental implant of FIG. 1.

FIG. 19 shows an enlarged view of the area of contact between the gold cylinder and the transephitelial abutment of FIG. 18.

FIG. 20 shows an elevation of an transephitelial impression coping and of a screw of the transephitelial impression coping according to the invention.

FIG. 21 shows a cross-sectional elevation of the transephitelial impression coping and the screw of FIG. 20.

FIG. 22 shows an elevation and a cross-sectional elevation of the transephitelial impression coping and the screw of FIG. 20 assembled on the transephitelial abutment and the first screw of FIG. 16, and on the dental implant of FIG. 1.

FIG. 23 shows an enlarged view of the area of contact between the transephitelial impression coping and the transephitelial abutment of FIG. 22.

FIG. 24 shows an elevation of a laboratory analog of the transephitelial abutment according to the invention.

FIG. 25 shows an example of set of parts or kit that makes up the dental implant and the associated parts according to the invention.

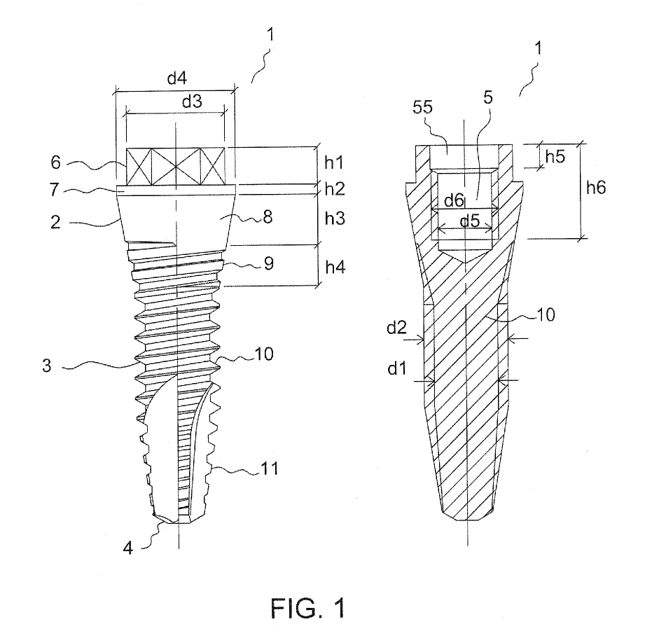

FIG. 1 shows an elevation and a cross-sectional elevation of an inventive narrow dental implant (1). The implant (1) is formed of a head (2), a threaded body (3) and an apical end or apex (4). The implant is solid and presents a blind threaded hole (5) in its interior, for the connection of a screw. According to the invention, the threaded body (3) comprises an upper conical threaded area (9) above the cylindrical threaded area (10) and a lower conical threaded area (11). The cylindrical threaded area (10) has an external diameter (d2) of between 2.5 and 3.25 mm and an internal diameter (d1) of between 1.9 and 2.7 mm. These diameters are smaller than the diameters of conventional implants, and provide the inventive dental implant with the quality of being ‘narrow’ and suitable for certain applications. The upper conical threaded area (9) presents a height (h4) of 1.2 mm and comprises a total of two turns of thread. The thread increases in depth as it approaches the cylindrical threaded area (10), said depth always being less than that of the threads of the cylindrical threaded area (10) in order to increase the thickness of the wall of the implant (1) in the area of the blind threaded hole (5) and thereby provide the implant (1) with greater robustness.

The head (2) of the implant (1) comprises a lower area (8), a cylindrical area (7) and a hexagonal protuberance (6). The lower area (8) is conical and has a height (h3) of 1.8 mm and a maximum diameter (d4) of 3.5 mm. In addition, the hexagonal protuberance (6) presents a diameter (d3) of the circumference circumscribed to the hex of between 2.8 and 3.0 mm and a height (h1) of 1.1 mm.

The blind threaded hole (5) of the implant (1) is shorter than the blind threaded holes present in conventional dental implants, so that it does not extend all the way to the cylindrical threaded area (10), which would be reducing the implant wall thickness to very fragile limits. In the inventive narrow implant (1) the blind threaded hole (5) has a height (h6) of between 2.5 and 3.0 mm and comprises a total of between 3 and 6 turns of thread, said thread presenting an internal diameter (d5) of between 1.3 and 1.7 mm and an external diameter (d6) of between 1.6 and 2.2 mm.

In addition, the blind threaded hole (5) includes a non-threaded first part (55) to help screws to be inserted, the height (h5) of this part (55) preferably being 0.7 mm.

The combination of a blind threaded hole (5) of the specified length, a conicity of the lower area (8) of the head (2) of the implant (1), and a reduction in the depth of the thread of the upper conical threaded area (9) makes the implant (1) especially robust and, thus, stronger.

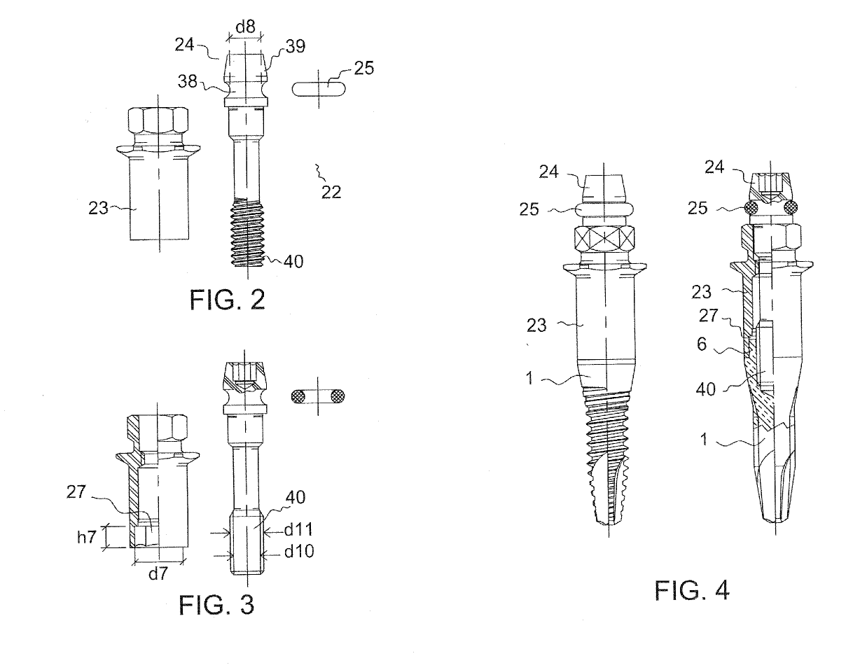

FIGS. 2 and 3 show an elevation and a cross-sectional elevation of a carrier unit (22) according to the invention. The carrier unit (22) comprises a bushing (23), an axis (24) and a seal (25). The bushing (23) is to be connected directly to the head (2) of the implant (1), and thus includes a hole (27) in which the hexagonal protuberance (6) of the head (2) of the implant (1) is housed. Said hole (27) has the dimensions of a female hex that match the dimensions of the hexagonal protuberance (6), therefore having a height (h7) of 1.1 mm and a diameter of the circumscribed circumference (d7) of between 2.8 and 3.0 mm. The axis (24) of the carrier unit (22) is screwed into the blind threaded hole (5) of the implant only between 4 and 6 turns of thread, and presents a threaded area (40) with an external diameter (d11) of between 1.6 and 2.2 mm and an internal diameter (d10) of between 1.3 and 1.7 mm. The area (38) of the axis (24) that houses the seal (25) presents a diameter (d8) of between 1.7 and 1.9 mm. Additionally, its upper end (39) is conical-shaped.

FIG. 4 shows the carrier unit (22) assembled on the dental implant (1), for which the bushing (23) has been connected onto hexagonal protuberance (6) of the implant (1) and the threaded area (40) of the axis (24) has been connected to the blind threaded hole (5) of the implant (1). The innovative characteristics of the implant (1) in combination with the innovative characteristics of the carrier unit (22) allow having narrow parts work properly in practice.

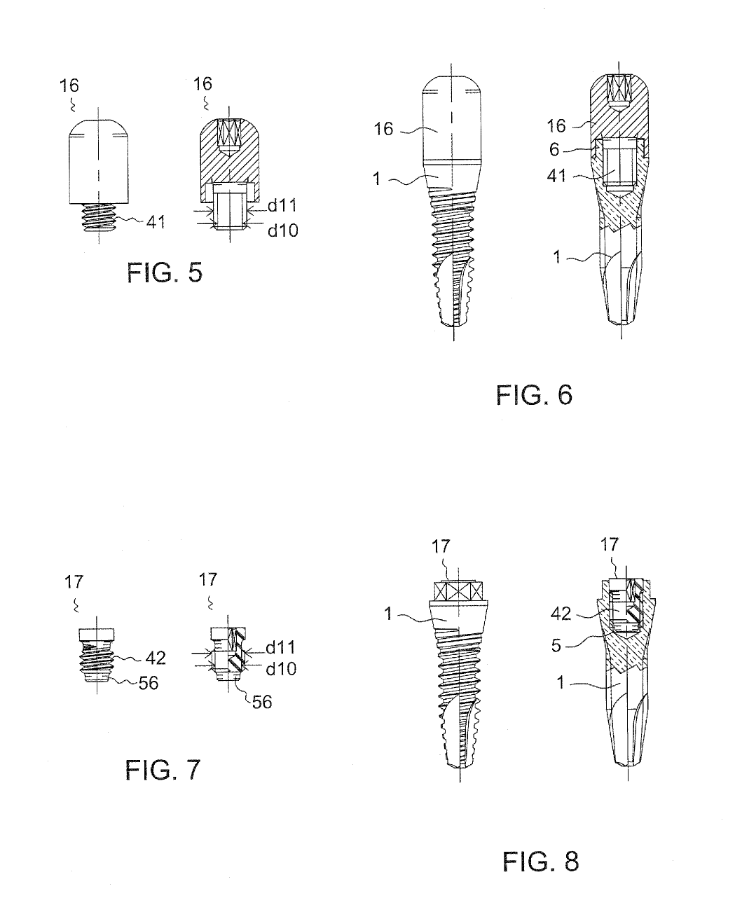

FIG. 5 shows an elevation and a cross-sectional elevation of a healing abutment (16) according to the invention, characterised in that it comprises a threaded area (41) provided with between 4 and 6 turns of thread. The threaded area (41) has an external diameter (d11) of between 1.6 and 2.2 mm and an internal diameter (d10) of between 1.3 and 1.7 mm. The healing abutment preferably presents a total height of 5.65, 6.65 or 8.65 mm.

FIG. 6 shows the healing abutment (16) assembled on the dental implant (1), more specifically having been connected onto the hexagonal protuberance (6) of the implant (1) and having screwed the threaded area (41) of the healing abutment (16) to the blind threaded hole (5) of the implant (1). The innovative characteristics of the implant (1) in combination with the innovative characteristics of the healing abutment (16) allow having narrow parts work properly in practice.

FIG. 7 shows an elevation and a cross-sectional elevation of a locking screw (17) according to the invention, characterised in that it comprises a threaded area (42) provided with between 3 and 6 turns of thread. The threaded area (42) has an external diameter (d11) of between 1.6 and 2.2 mm and an internal diameter (d10) of between 1.3 and 1.7 mm. Said threaded area (42) also has the particular feature of ending in a non-threaded end (56), whose purpose is to help insert the locking screw (17) in the implant (1).

FIG. 8 shows the locking screw (17) assembled on the dental implant (1) according to the invention, after the threaded area (42) of the locking screw (17) has been connected to the blind threaded hole (5) of the implant (1). The innovative characteristics of the implant (1) in combination with the innovative characteristics of the locking screw (17) allow having narrow parts work properly in practice.

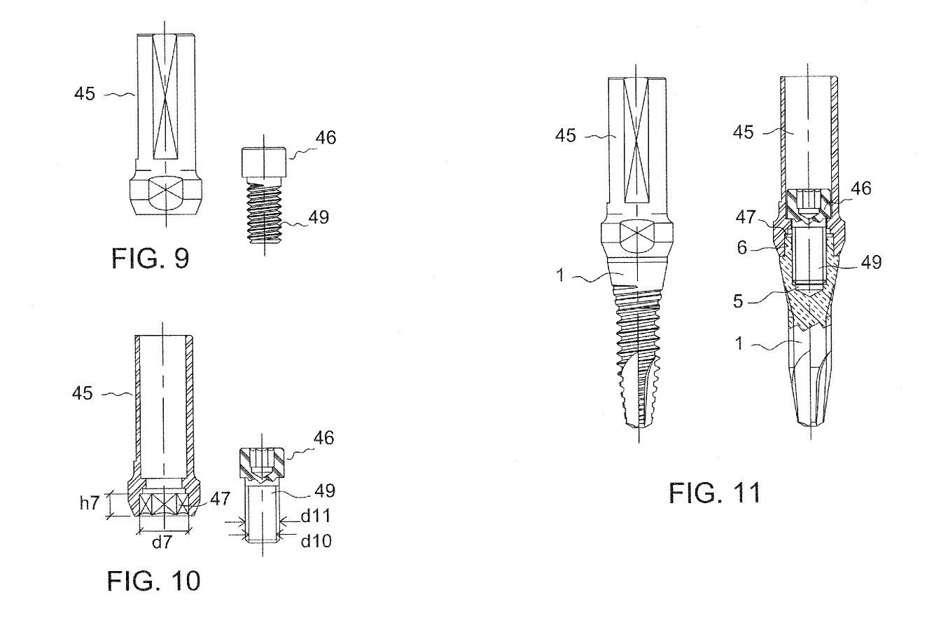

FIGS. 9 and 10 show an elevation and a cross-sectional elevation of a final abutment (45) and a retention screw (46) according to the invention. The retention screw (46) is screwed into the blind threaded hole (5) of the implant only between 4 and 6 turns of thread, and thus presents a threaded area (49) with an external diameter (d11) of between 1.6 and 2.2 mm and an internal diameter (d10) of between 1.3 and 1.7 mm. The final abutment (45) is connected directly to the head (2) of the implant (1), and thus includes a hexagonal hole (47) in which the hexagonal protuberance (6) of the head (2) is housed. For this purpose said hole (47) has a diameter of the circumscribed circumference (d7) of between 2.8 and 3.0 mm and a height (h7) of 1.1 mm.

FIG. 11 shows the final abutment (45) and the retention screw (46) assembled on the dental implant (1) according to the invention, after having connected the hole (47) of the final abutment onto the hexagonal protuberance (6) of the implant (1) and after having connected the threaded area (49) of the retention screw (46) to the blind threaded hole (5) of the implant (1). The innovative characteristics of the implant (1) in combination with the innovative characteristics of the final abutment (45) and the retention screw (46) allow having narrow parts work properly in practice.

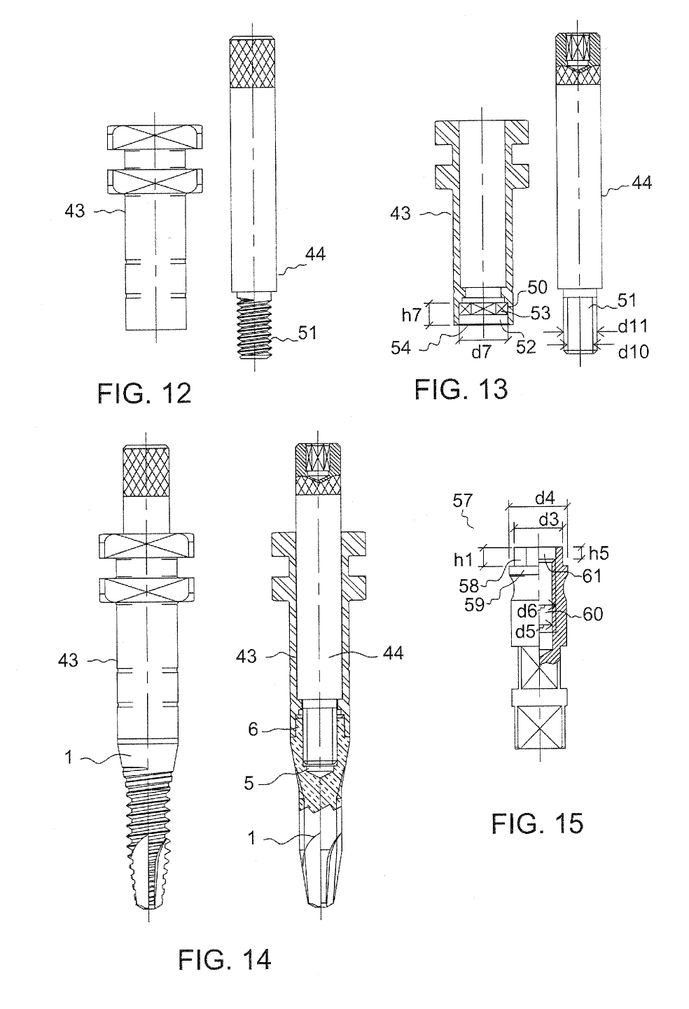

FIGS. 12 and 13 show an elevation and a cross-sectional elevation of an implant impression coping (43) and the screw (44) of the implant impression coping. The implant impression coping (43) is connected directly to the head (2) of the implant (1), and thus includes a hole (50) in which the hexagonal protuberance (6) of the head (2) of the implant (1) is housed. The hole (50) comprises a cylindrical part (52) and a hexagonal part (53). The hexagonal part (53) has a diameter of the circumference circumscribed to the hex (d7) of between 2.8 and 3.0 mm. The hole (50) has a height (h7) of 1.1 mm. The cylindrical part (52) ends in a rabbet (54). The screw (44) of the implant impression coping comprises a threaded area (51) that is screwed between 4 and 6 turns of thread in the blind threaded hole (5) of the implant (1). Said threaded area (51) has an internal diameter (d10) of between 1.3 and 1.7 mm and an external diameter (d11) of between 1.6 and 2.2 mm.

FIG. 14 shows the implant impression coping (43) and the screw (44) of the implant impression coping assembled on the dental implant (1) according to the invention, after having connected the hole (50) of the implant impression coping (43) onto the hexagonal protuberance (6) of the implant (1) and after having connected the threaded area (51) of the screw (44) to the blind threaded hole (5) of the implant (1). The innovative characteristics of the implant (1) in combination with the innovative characteristics of the implant impression coping (43) and the screw (44) allow having narrow parts work properly in practice.

FIG. 15 shows a laboratory analog (57) of the unitary implant according to the invention, the head of which is intended to be an exact replica of the head of the narrow implant according to the invention. For this purpose, the laboratory analog's head is provided with a hexagonal protuberance (58) whose height (h1) is 1.1 mm and whose circumscribed circumference diameter (d3) is between 2.8 and 3.0 mm. Also, the head comprises a cylindrical area (59) of a diameter equal to 3.5 mm. Like the implant the laboratory analog (57) includes a blind threaded hole (60) with an internal diameter (d5) of between 1.3 and 1.7 mm and an external diameter (d6) of between 1.6 and 2.2 mm. In the embodiment of the figure, the blind threaded hole (60) starts with a non-threaded area (61) of a height of 0.7 mm.

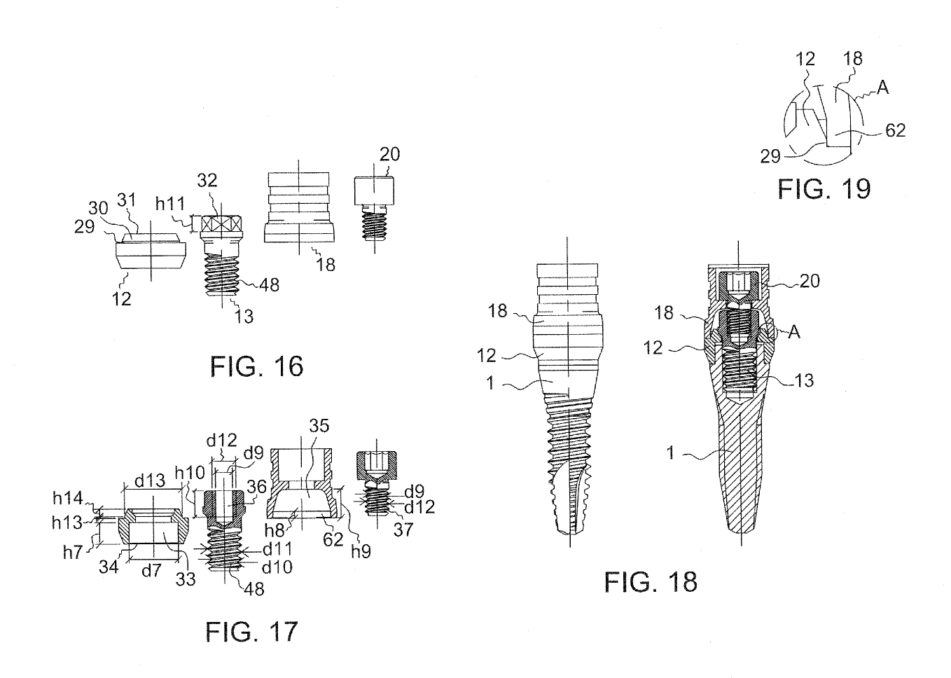

FIGS. 16 and 17 show an elevation and a cross-sectional elevation of a transephitelial abutment (12), a first screw (13) to fix the transephitelial abutment (12) to the implant (1), a gold cylinder (18) and a second screw (20) to fix the gold cylinder (18) to the first screw (13). The transephitelial abutment (12) is connected directly to the head (2) of the implant (1), and thus includes a hole (33) in which the hexagonal protuberance (6) of the head (2) of the implant (1) is housed. Said hole (33) has cylindrical dimensions that fit the hexagonal protuberance (6) of the implant (1) but that allow the transephitelial abutment (12) to rotate in relation to the implant (1), the transephitelial abutment (12) remaining centred in relation to the implant (1) at all times. Furthermore, in order to help fit the transephitelial abutment (12) onto the implant (1), said hole (33) ends in its lowest area in a widened section (34), in the form of a bevel or rounded area. In the event that the widened section (34) is in the form of a rounded area, the radius of the rounded area is preferably 20 micron.

The transephitelial abutment (12) presents an upper part (31) that comprises a conical part (30) and a cylindrical part (29). The height of the upper part (31) is preferably between 0.3 and 0.8 mm, the heights of the conical part (30) and cylindrical part (29) preferably being 0.45 and 0.1 mm respectively. The diameter (d13) of the cylindrical part is between 3.3 and 3.5 mm.

The first screw (13) is characterised in that it presents a threaded area (48) provided with between 4 and 6 turns of thread. The threaded area (48) has an external diameter (d11) of between 1.6 and 2.2 mm and an internal diameter (d10) of between 1.3 and 1.7 mm. Additionally, this screw (13) is provided with a hexagonal protuberance (32) with a height (h11) of between 0.9 and 1.1 mm. A blind threaded hole (36) opens up from this hexagonal protuberance (32), said blind threaded hole (36) containing between 4 and 6 turns of thread and having a height (h10) of between 1.55 and 2.15 mm. The blind threaded hole (36) also has an internal diameter (d9) of between 1.0 and 1.2 mm and an external diameter (d12) of between 1.9 and 2.1 mm.

The second screw (20) comprises a threaded area (37) adapted so that it can be connected to the blind threaded hole (36) of the first screw (13). For this purpose, said threaded area (37) features between 4 and 6 turns of thread.

The gold cylinder (18) presents a hole (35) designed to house the upper part (31) of the transephitelial abutment (12) and the hexagonal protuberance (32) of the first screw (13), for which reason said hole (35) presents a height (h9) of between 1.7 and 1.9 mm. Additionally, hole (35) comprises a cylindrical part (62) with a diameter of between 3.3 and 3.5 mm and a height (h8) of 0.4 mm. A correct connection/disconnection of the gold cylinder (18) to/from the transephitelial abutment (12) in the case of varied angulations is ensured thanks to two features: first, said height (h8) being optimal; second, the fact that when the gold cylinder (18) is connected to the transephitelial abutment (12), both come into contact with each other only in the cylindrical part (62) of the hole (35) of the gold cylinder (18), and not in the rest of said hole (35). This last characteristic is enlarged in FIG. 19, showing zone A of FIG. 18. It can be seen how the adjustment between the transephitelial abutment (12) and the gold cylinder (18) takes place only where its cylindrical parts (29, 62) come into contact and become adjusted.

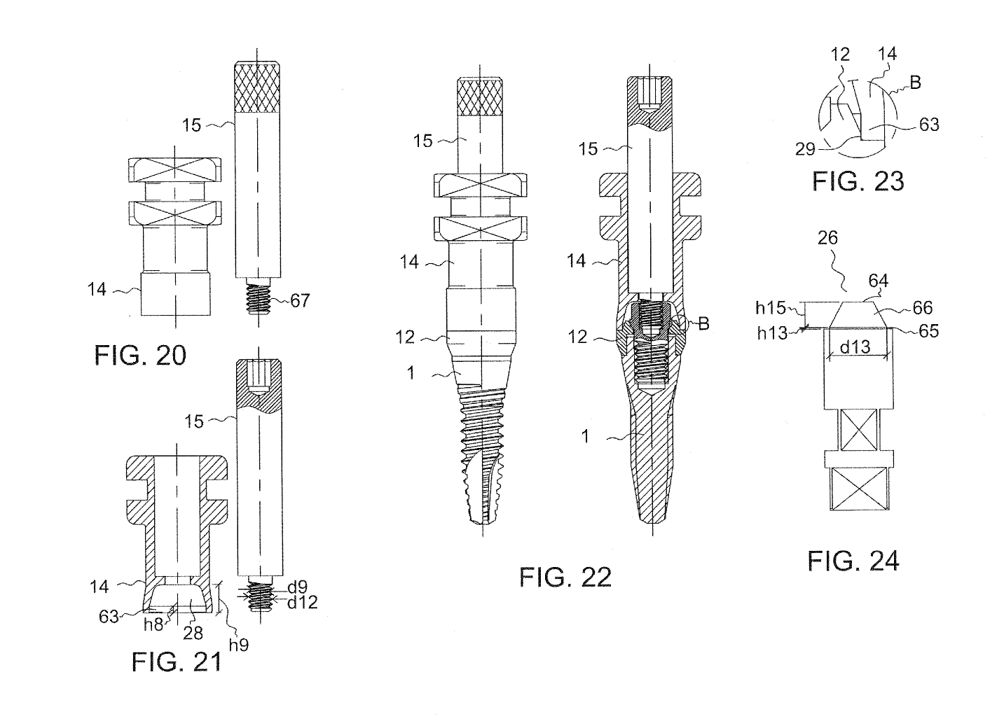

FIGS. 20 and 21 show an elevation and a cross-sectional elevation of an transephitelial impression coping (14) and a screw (15) of the transephitelial impression coping according to the invention. The transephitelial impression coping (14) includes a hole (28) in which the conical part (30) and the cylindrical part (29) of the upper part (31) of the transephitelial abutment (12) are housed, The characteristics of this hole (28) are the same as those of the hole (35) of the gold cylinder (18) of FIGS. 16, 17 and 18. The screw (15) of the transephitelial impression coping presents a threaded area (67) that comprises between 4 and 6 turns of thread and that has an internal diameter (d9) of between 1.0 and 1.2 mm and an external diameter (d12) of between 1.9 and 2.1 mm.

FIG. 22 shows the transephitelial impression coping (14) and the screw (15) of the transephitelial impression coping assembled on the dental implant (1) according to the invention, after having connected the hole (28) of the transephitelial impression coping (14) onto the hexagonal protuberance (6) of the implant (1) and after having connected the threaded area (67) of the screw (15) to the blind threaded hole (5) of the implant (1). The innovative characteristics of the implant (1) in combination with the innovative characteristics of the transephitelial impression coping (14) and the screw (15) allow having narrow parts work properly in practice.

FIG. 23 shows an enlarged view of zone B of FIG. 22, that is just as that shown in FIG. 19. In other words, the adjustment between the transephitelial abutment (12) and the transephitelial impression coping (14) is based on the contact and adjustment only of its cylindrical parts (29, 63).

FIG. 24 shows a laboratory analog (26) of the unit formed by the implant and the transephitelial abutment, The head (64) of the laboratory analog must simulate the upper part (31) of the transephitelial abutment (12). For this reason, the head (64) of the laboratory analog (26) presents a cylindrical part (65) of a height (h13) equal to 0.1 mm and a diameter (d13) of between 3.3 and 3.5 mm, and a conical part (66) of equal conicity to the conical part (30) of the upper part (31) of the transephitelial abutment (12).

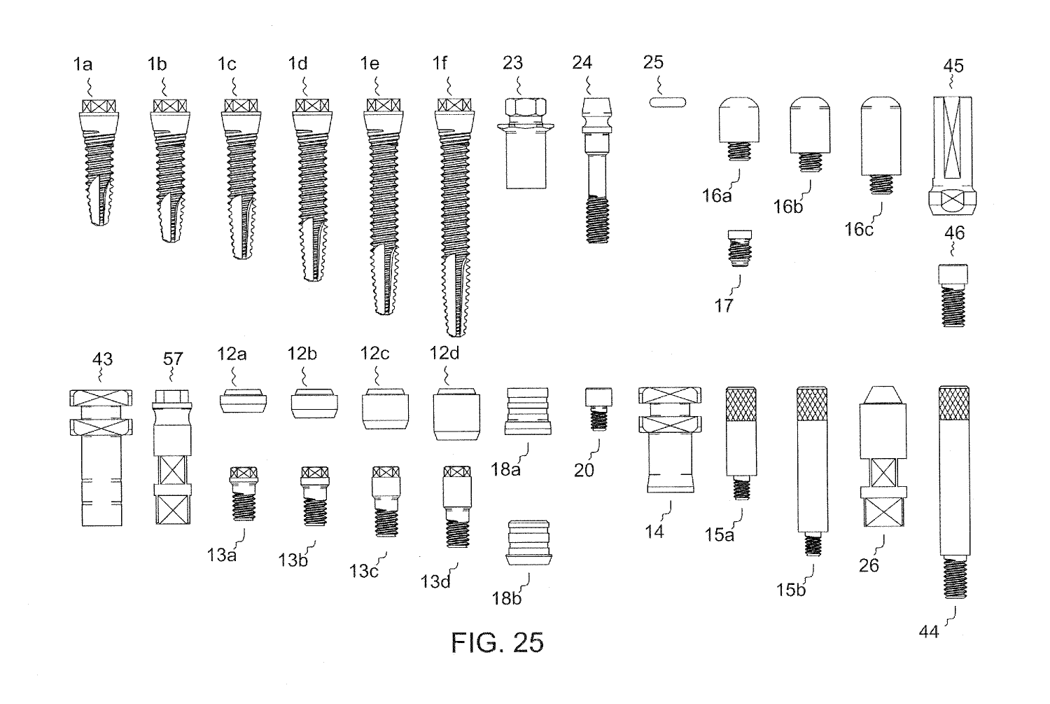

FIG. 25 shows a possible kit or joint presentation of various dental implants and associated parts according to the invention. It can be seen that the kit includes, among the parts described in the figures above, various-sized embodiments of dental implants (1a, 1b, 1c, 1d, 1e, 1f), healing abutments (16a, 16b, 16c), transephitelial abutments (12a, 12b, 12c, 12d), screws (13a, 13b, 13c, 13d) to fix the transephitelial abutment (12) to the implant (1), screws (15a, 15b, 15c) of the transephitelial impression coping, and two gold cylinders (18a, 18b).

1. Dental implant (1), comprising a head (2) and a threaded body (3), and in which a blind threaded hole (5) is disposed, where the head (2) comprises a lower area (8), a cylindrical area (7) and a hexagonal protuberance (6), where the threaded body (3) comprises a cylindrical threaded area (10) and a lower conical threaded area (11), wherein:
the cylindrical threaded area (10) has an internal diameter (d1) of between 1.9 and 2.7 mm and an external diameter (d2) of between 2.5 and 3.25 mm,
the threaded body (3) comprises an upper conical threaded area (9) formed between the head (2) and the cylindrical threaded area (10), where in said upper conical threaded area (9) the thread increases in depth as it approaches the cylindrical threaded area (10), said depth always being less than that of the threads of the cylindrical threaded area (10),
the blind threaded hole (5) has a height (h6) of between 2.5 and 3.0 mm and comprises a total of between 3 and 6 turns of thread, and
the blind threaded hole (5) presents an internal diameter (d5) of between 1.3 and 1.7 mm and an external diameter (d6) of between 1.6 and 2.2 mm.

2. Dental implant (1), according to claim 1, wherein:
the hexagonal protuberance (6) has a height (h1) of 1.1 mm and a diameter of the circumscribed circumference (d3) of between 2.8 and 3.0 mm,
the lower area (8) has a height (h3) of 1.8 mm and a maximum diameter (d4) of 3.5 mm, and
the upper conical threaded area (9) has a height (h4) of 1.2 mm and comprises a total of two turns of thread.

3. Dental implant (1), according to claim 1, wherein the blind threaded hole (5) includes a non-threaded first part (55).

4. Dental implant (1), according to claim 3, wherein the first non-threaded part (55) has a height (h5) of 0.7 mm.

5. Axis (24) of a carrier unit (22), which comprises an upper end (39) for the connection of a tool, an area (38) in which a seal (25) is housed, and a threaded area (40) for its connection to the blind threaded hole (5) of a dental implant (1), wherein:
the upper end (39) is conical, and
the area (38) has a diameter (d6) of between 1.7 and 1.9 mm.

6. Transephitelial abutment (12), which comprises an upper part (31), wherein:
the upper part (31) comprises a conical part (30) and a cylindrical part (29), and
the height of the conical part (30) and the cylindrical part (29) is 0.45 and 0.1 mm respectively, the diameter (d13) of the cylindrical part (29) being between 3.3 and 3.5 mm.

7. Screw (13) for connecting a transephitelial abutment (12) to a dental implant, where the screw (13) comprises a hexagonal protuberance (32) provided with a blind threaded hole (36), wherein:
the blind threaded hole (36) comprises between 4 and 6 turns of thread, and has a height (h10) of between 1.55 and 2.15 mm, an internal diameter (d9) of between 1.0 and 1.2 mm, and an external diameter (d12) of between 1.9 and 2.1 mm, and
the hexagonal protuberance (32) has a height (h11) of between 0.9 and 1.1 mm.

8. Part associated to a dental implant, where said associated part is an axis (24) of a carrier unit (22), a healing abutment (16), a locking screw (17), a retention screw (46), a screw (44) of an impression coping of a unitary implant, a screw (13) to connect a transephitelial abutment (12) to the dental implant, or in general a screw designed to be connected to the blind threaded hole (5) of a dental implant (1) of the type claimed in claim 1, and for which reason the part is provided with a threaded area (40, 41, 42, 49, 51, 48), wherein the threaded area (40, 41, 42, 49, 51, 48) has an external diameter (d11) of between 1.6 and 2.2 mm and an internal diameter (d10) of between 1.3 and 1.7 mm.

9. Healing abutment (16) or screw (13) for connecting a transephitelial abutment (12) to the dental implant, according to claim 8, wherein the threaded area (41, 48) comprises between 4 and 6 turns of thread.

10. Locking screw (17), according to claim 8, wherein:
the threaded area (42) of the locking screw (17) has between 3 and 6 turns of thread, and
the threaded area (42) of the locking screw (17) ends in a non-threaded end (56) to help insert the locking screw (17) when it is to be screwed in.

11. Part associated to a dental implant, where said associated part is a bushing (23) of a carrier unit (22), a final abutment (45), an implant impression coping (43), a transephitelial abutment (12), or in general a part designed to connect to and embrace the hexagonal protuberance (6) of a dental implant (1) of the type claimed in claim 2, and for which reason the part is provided with a hole (27, 47, 50, 33), the hole optionally being totally cylindrical (33), totally hexagonal (27, 47), or partially cylindrical (50) comprising a hexagonal part (53), wherein:
the circumferences circumscribed to the hex of the hexagonal hole (27, 47) or to the hex of the hexagonal part (53), and the totally cylindrical hole (33) present a diameter (d7) of between 2.8 and 3.0 mm, and
the hole (27, 47, 50, 33) has a height (h7) of 1.1 mm.

12. Part associated to a dental implant, according to claim 11, wherein the hole (27, 47, 50, 33) ends in a rabbet (54) or widened section (34).

13. Part associated to a dental implant, where said associated part is a laboratory analog (57) of a unitary implant, or in general a part designed to exactly imitate the area of connection of a dental implant (1) of the type claimed in claim 1, and for which reason the part is provided with a hexagonal protuberance (58), a blind threaded hole (60) and a cylindrical area (59), wherein:
the blind threaded hole (60) has an internal diameter (d5) of between 1.3 and 1.7 mm and an external diameter (d6) of between 1.6 and 2.2 mm.

14. Part associated to a dental implant, according to claim 13, wherein:
the hexagonal protuberance (58) has a height (h1) of 1.1 mm and a diameter (d3) of the circumference circumscribed to the hex of 2.9 mm, and
the diameter (d4) of the cylindrical area (59) is 3.5 mm.

15. Part associated to a dental implant, according to claim 13, wherein the blind threaded hole (60) ends in a non-threaded area (61).

16. Part associated to a dental implant, according to claim 15, wherein the non-threaded area (61) has a height of 0.7 mm.

17. Part associated to a dental implant, where said associated part is a screw (20) or a screw (15) for connecting a gold cylinder or an impression coping (14) to a screw (13) of the type claimed in claim 7, where the screw (20, 15) comprises a threaded area (37, 67), wherein the threaded area (37, 67) comprises between 4 and 6 turns of thread and presents an internal diameter (d9) of between 1.0 and 1.2 mm and an external diameter (d12) of between 1.9 and 2.1 mm.

18. Part associated to an implant and to a transephitelial abutment, where said associated part is a laboratory analog (26) of a dental implant and transephitelial abutment, or in general a part designed to imitate exactly the upper part (31) of a transephitelial abutment (12) of the type claimed in claim 6, and for which reason the part is provided with a head (64), wherein:
the head (64) comprises a cylindrical part (65) and a conical part (66), and
the cylindrical part (65) has a height (h13) equal to 0.1 mm and a diameter (d13) of between 3.3 and 3.5 mm.

19. Part associated to an implant, where said associated part is a gold cylinder (18), an transephitelial impression coping (14), or in general a part designed to be connected to a transephitelial abutment (12) of the type claimed in claim 6, and for which reason the part is provided with a hole (35, 28) designed to embrace the upper part (31) of said transephitelial abutment (12), wherein:
the hole (35, 28) has a height (h9) of between 1.7 and 1.9 mm,
the hole (35, 28) comprises a cylindrical part (62, 63) the height (h8) of which is 0.4 mm and the diameter (d13) of which is between 3.3 and 3.5 mm, and
when the associated part (18, 14) is connected to the transephitelial abutment (12), the adjustment between the transephitelial abutment (12) and the associated part (18, 14) takes place only where the cylindrical part (29) of the transephitelial abutment (12) and the cylindrical parts of the associated part (62, 63) come into contact and are adjusted.

20. Axis (24) of a carrier unit (22), according to claim 5, wherein it also comprises the characteristics in that the treaded area (40, 41, 42, 49, 51, 48) has an external diameter (d11) of between 1.6 and 2.2 mm and an internal diameter (d10) of between 1.3 and 1.7 mm.

21. Transephitelial abutment (12), according to claim 6, wherein:
the circumferences circumscribed to the hex of the hexagonal hole (27, 47) or to the hex of the hexagonal part (53), and the totally cylindrical hole (330 present a diameter (d7) of between 2.8 and 3.0 mm, and
the hold (27, 47, 50, 33) has a height (h7) of 1.1 mm.

22. Transephitelial abutment (12), according to claim 6, wherein:
the circumferences circumscribed to the hex of the hexagonal hole (27, 47) or to the hex of the hexagonal part (53), and the totally cylindrical hole (33) present a diameter (d7) of between 2.8 and 3.0 mm, and
the hole (27, 47, 50, 33) has a height (h7) of 1.1 mm.

23. Screw (13), according to claim 7, wherein the threaded area (40, 41, 42, 49, 51, 48) has an external diameter (d11) of between 1.6 and 2.2 mm and an internal diameter (d10) of between 1.3 and 1.7 mm.

24. Kit or set of parts, comprising at least two parts selected from the following:
a. dental implant (1), comprising a head (2) and a threaded body (3), and in which a blind threaded hole (5) is disposed, where the head (2) comprises a lower area (8), a cylindrical area (7) and a hexagonal protuberance (6), where the threaded body (3) comprises a cylindrical threaded area (10) and a lower conical threaded area (11), wherein the cylindrical threaded area (10) has an internal diameter (d1) of between 1.9 and 2.7 mm and an external diameter (d2) of between 2.5 and 3.25 mm, the threaded body (3) comprises an upper conical threaded area (9) formed between the head (2) and the cylindrical threaded area (10), wherein said upper conical threaded area (9) the thread increases in depth as it approaches the cylindrical threaded area (10), said depth always being less than that of the threads of the cylindrical threaded area (10), the blind threaded hole (5) has a height (h6) of between 2.5 and 3.0 mm and comprises a total of between 3 and 6 turns of thread, and the blind threaded hole (5) presents an internal diameter (d5) of between 1.3 and 1.7 mm and an external diameter (d6) of between 1.6 and 2.2 mm;
b. axis (24) of a carrier unit (22), which comprises an upper end (39) for the connection of a tool, an area (38) in which a seal (25) is housed, and a threaded area (40) for its connection to the blind threaded hole (5) of a dental implant (1), wherein the upper end (39) is conical, the area (38) has a diameter (d6) of between 1.7 and 1.9 mm;
c. transephitelial abutment (12), which comprises an upper part (31), wherein the upper part (31) comprises a conical part (30) and a cylindrical part (29), the height of the conical part (30) and the cylindrical part (29) is 0.45 and 0.1 mm respectively, and the diameter (d13) of the cylindrical part (29) being between 3.3 and 3.5 mm; and
d. screw (13) for connecting a transephitelial abutment (12) to a dental implant, where the screw (13) comprises a hexagonal protuberance (32) provided with a blind threaded hole (36), wherein the blind threaded hole (36) comprises between 4 and 6 turns of thread, and has a height (h10) of between 1.55 and 2.15 mm, an internal diameter (d9) of between 1.0 and 1.2 mm, and an external diameter (d12) of between 1.9 and 2.1 mm, and the hexagonal protuberance (32) has a height (h11) of between 0.9 and 1.1 mm.

25. Part associated to a dental implant, where said associated part is an axis (24) of a carrier unit (22), a healing abutment (16), a locking screw (17), a retention screw (46), a screw (44) of an impression coping of a unitary implant, a screw (13) to connect a transephitelial abutment (12) to the dental implant, or in general a screw designed to be connected to the blind threaded hole (5) of a dental implant (1) of the type claimed in claim 5, and for which reason the part is provided with a threaded area (40, 41, 42, 49, 51, 48), wherein the threaded area (40, 41, 42, 49, 51, 48) has an external diameter (d11) of between 1.6 and 2.2 mm and an internal diameter (d10) of between 1.3 and 1.7 mm.

26. Part associated to a dental implant, where said associated part is an axis (24) of a carrier unit (22), a healing abutment (16), a locking screw (17), a retention screw (46), a screw (44) of an impression coping of a unitary implant, a screw (13) to connect a transephitelial abutment (12) to the dental implant, or in general a screw designed to be connected to the blind threaded hole (5) of a dental implant (1) of the type claimed in claim 6, and for which reason the part is provided with a threaded area (40, 41, 42, 49, 51, 48), wherein the threaded area (40, 41, 42, 49, 51, 48) has an external diameter (d11) of between 1.6 and 2.2 mm and an internal diameter (d10) of between 1.3 and 1.7 mm.

27. Part associated to a dental implant, where said associated part is an axis (24) of a carrier unit (22), a healing abutment (16), a locking screw (17), a retention screw (46), a screw (44) of an impression coping of a unitary implant, a screw (13) to connect a transephitelial abutment (12) to the dental implant, or in general a screw designed to be connected to the blind threaded hole (5) of a dental implant (1) of the type claimed in claim 7, and for which reason the part is provided with a threaded area (40, 41, 42, 49, 51, 48), wherein the threaded area (40, 41, 42, 49, 51, 48) has an external diameter (d11) of between 1.6 and 2.2 mm and an internal diameter (d10) of between 1.3 and 1.7 mm.
